(19) United States
(12) Patent Application Publication
(10) Pub. No.: US 2026/0091381 A1
(43) Pub. Date: Apr. 2, 2026

(54) ETHYLENE OXIDE NEUTRALIZING MATERIAL INCORPORATING ION EXCHANGE RESINS

(71) Applicant: ChemDAQ Inc., Pittsburgh, PA (US)

(72) Inventors: Induvadana Ankareddi, Sewickley, PA (US); Chibuike Okoro, McKees Rocks, PA (US); David M. Hilliker, Clinton, PA (US); Piers Richard Warburton, Sewickley, PA (US)

(21) Appl. No.: 19/347,966

(22) Filed: Oct. 2, 2025

Related U.S. Application Data
(60) Provisional application No. 63/702,375, filed on Oct. 2, 2024.

(51) Int. Cl. B01J 47/127; B01D 53/72; B01D 53/82; B01J 39/04; B01J 39/18

(52) U.S. Cl. CPC B01J 47/127; B01D 53/72; B01D 53/82; B01J 39/04; B01J 39/18; B01D 2253/206; B01D 2253/25; B01D 2253/304; B01D 2257/708; B01D 2258/06

(57) ABSTRACT

A composition hereof include a substrate, which is flexible. and particles of an ion exchange resin immobilized at least one of upon or within the substrate. The ion exchange resin interacts with ethylene oxide to decrease concentration of ethylene oxide in an environment.

### CROSS-REFERENCE TO RELATED APPLICATIONS

This application claims benefit of U.S. Provisional Patent Application Ser. No. 63/702,375, filed Oct. 2, 2024, the disclosure of which is incorporated herein by reference.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Ethylene oxide (EtO) is a reactive gas which has been used to sterilize medical devices since the 1950s. It has been reported that over 50% of medical devices are sterilized with EtO. EtO has several key advantages over competing sterilization technologies, including: 1) excellent chemical compatibility, 2) no damage to medical devices stored, and 3) excellent penetrating ability. Medical devices can thus be sterilized in their final packaging and even by the pallet.

The excellent penetration properties of EtO also present problems, however. Although EtO can readily penetrate packaging and even diffuse through some plastics in sterilization processes, EtO is slow to diffuse out of the medical devices post-sterilization. EtO, which is a known carcinogen, presents a significant exposure risk above certain levels. See, for example, 1,3-Butadiene, Ethylene Oxide and Vinyl Halides (Vinyl Fluoride, Vinyl Chloride and Vinyl Bromide), IARC Monographs on the Evaluation of Carcinogenic Risks to Humans Volume 97, IARC, ISBN-13978-92-832-1297-3 (2008).

The off-gassing of EtO from sterilized equipment is typically an approximately exponential decay. The half-life and the rate of off-gassing or outgassing depends on many factors such as the temperature, the packaging used, the materials used, and the manner the packages are assembled. There is thus no sharp, predetermined endpoint for the outgassing. Medical device manufacturers (MDMs) and contract sterilization companies (CSCs) must use their best judgment in determining a time when the outgassing is sufficiently complete to allow the product to be shipped to the end user or, more commonly, to a warehouse for later distribution. If they delay too long, the supply chain is unnecessarily delayed. If they ship too soon, there is a risk that the medical devices will continue to off-gas significant amounts of EtO during transportation.

Medical devices are typically shipped by the pallet in truck trailers over land, and by shipping containers for international transportation. A small fraction of high-value, low-volume medical devices is also transported by air. If the trailer or container is sealed, the off-gassed EtO can build up inside. The build-up of EtO can present a hazard at the destination, where the pallets are removed from the trailer or container, or when the shipping container is inspected by customs. To prevent occupational exposure to EtO, most organizations which receive shipments of recently EtO-sterilized equipment use continuous monitors to ensure that the EtO concentration is below occupational exposure limits. The portable and fixed monitors used to measure the EtO concentrations are commercially available, such as those available from ChemDAQ Inc. (Pittsburgh, PA). In the United States, permissible exposure limits are promulgated by the Occupational Safety and Health Administration (OSHA). See 29 CFR 1910.1047; and most other countries have similar exposure regulations for EtO.

As described above, people at facilities receiving EtO sterilized medical devices are at risk of being exposed to excessive concentrations of EtO when they open truck trailers and shipping containers and unpack pallets. The concentration of EtO in the trailer depends on many variables including the size and composition of the load, the travel time, temperature, sterilization cycle and aeration times. EtO concentrations in a trailer when it arrives at its destination thus vary greatly from a few parts per million (ppm) up to several hundred ppm, well over the OSHA Permissible Exposure Limit of 1 ppm (8 hour time weighted average). 29 CFR 1910.1047. CSCs that use EtO also have to ensure that waste EtO from the sterilization process is not released into the air to protect their workers and to comply with US Environmental Protection Agency (EPA) emission requirements and state permits. 40 CFR 63, subpart O.

In April 2023, the EPA proposed new regulations that would require, among other things, that workers in sterilization facilities not be exposed to more than 10 ppb EtO in the air workplace. Most of the EtO in the sterilization facilities' warehouses comes from EtO off-gassing from EtO sterilized pallets. Relatively little EtO comes from the sterilizers or aeration rooms since these rooms typically exhaust to scrubbers where the EtO is destroyed.

Because more than 20 billion medical devices are sterilized by EtO each year in the US alone, and many more are sterilized in other countries, EtO exposure from off-gassing medical devices is a common and well-known problem which has been described many times in the literature. EtO off-gassing is also known to be a problem in other industries that use EtO as a fumigant, for example museum and library archives.

EtO off-gassing presents an occupational inhalation exposure risk as well as uncontrolled emissions of EtO into the atmosphere. The primary solutions currently applied in mitigating EtO off-gassing include 1) allowing the product to aerate longer before shipping (with the concomitant cost to the supply chain), 2) adding ventilation to the truck trailers and shipping containers (which is not always practical since most trucks and trailers used for transporting medical devices are common carriers), 3) allowing the trailers and containers to aerate after opening and before unloading and/or inspection (which causes delays), and 4) packing the pallets so that there are aeration channels to facilitate loss of EtO. All of these measures have been applied, with limited success and additional costs.

There are several technologies used outside the area of mitigating off-gassing of EtO to destroy waste EtO. The most commonly used technology is a sulfuric acid scrubber in which the EtO-containing air is passed through the scrubber such that the air stream intimately contacts an aqueous solution of sulfuric acid, which absorbs the EtO and hydrolyzes it to ethylene glycol according to the following reaction:

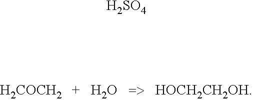

The scrubber technology removes EtO well, typically removing more than 99% of the EtO. However, it is impractical to place a sulfuric acid scrubber inside of a pallet of medical devices. In that regard, a spill of acid would result in damage to the medical devices. Moreover, even if the acid were restrained within a container, there is always a risk during shipping of an accident, potentially rupturing the sulfuric acid container. It is also difficult to keep sulfuric acid within a mobile container designed to admit gas. If the acid were to escape, it may pose a greater risk to personnel unloading the trailer or container than the EtO the acid was designed to remove.

Another technology that is used to remove EtO uses strong acid ion exchange resins (IERs) in which sulfonate moieties are attached to a polystyrene backbone. IERs, when used in scrubber vessels, are known to reduce small amounts of EtO in an air stream to even lower concentrations. An example of EtO pollution control equipment based on IER is the Safe-Cell™ scrubbing systems available from Advanced Air Technologies Inc. of Corunna, Michigan. The underlying technology is described, for example, in U.S. Pat. No. 4,828,810. The IERs are provided in the form of beads or powder which are installed in relatively large stainless steel vessels which the air to be scrubbed is passed through. IER-based scrubbers work well, but are quite large and heavy, and tend to be expensive. Moreover, the small beads thereof are difficult to clean up in case of a spill.

Other EtO removing filters have been made from zeolites in the acid form. See, for example, U.S. Pat. No. 6,837,917. The present inventors are not aware of any commercially available zeolite-based systems.

Another technology for EtO removal is catalytic oxidation in which the EtO gas is oxidized at high temperature to carbon dioxide and water. Systems such as those available from Lesni A/S, Billund (Denmark) remove EtO well. For example, the Lesni system will destroy at least 99% of the EtO. In hospitals, similar but much smaller devices known as abators are used to remove EtO from waste streams from EtO sterilizers. A representative design is the 3M™ EO Abator Model 50 System (available from 3M of Minneapolis, MN). That system operates by passing the air stream over a heated catalyst, which again catalytically oxidizes the EtO to carbon dioxide and water.

All the systems described above work well, but they are large and very capital expensive for purchase and installation. Most of such systems also require significant energy to operate. Such factors and other factors make such systems unsuitable for use, for example, to remove EtO from truck trailers, pallets, or shipping containers. Further, the high capital and energy expenditures are not possible for many sterilization facilities.

Gas absorbers, such as activated carbon, may also remove EtO. Although activated carbon will absorb EtO, the process is reversible. Once a previously used carbon absorber is placed in a clean atmosphere, the absorption equilibrium will be reversed, and the EtO will be released to the surrounding atmosphere, presenting a potential hazard to people nearby.

IERs have also been used in paint coatings. For example, European Patent No. EP0837110 and U.S. Pat. No. 3,494,878 disclose paint coatings including IER particles for use in connection with substrates that tend to stain such as cedar, redwood, and mahogany, substrates that tend to rust such as nail heads etc., and substrates that potentially may undergo nicotine staining (for example, when exposed to cigarette smoke), water spotting, efflorescence, or tannin staining.

It is desirable to develop materials, devices, systems and methods to effectively neutralize EtO off-gassing after EtO sterilization and aeration (for example, as the pallets wait to be shipped in warehouses) without the requirement of purchasing expensive capital equipment. Such materials, devices, systems and methods should, for example, capture and neutralize the EtO emissions from each pallet after sterilization and before these emissions are released into the indoor air. Published PCT International Patent Application No. WO2021050920A1 discloses a suitable material that functions well and has high capacity to remove EtO. However, the material is more expensive to produce than is desirable for a single-use, disposable product. It thus remains desirable to develop improved materials and methods to address the problems associated with EtO off-gassing.

### SUMMARY

A composition hereof includes a substrate material, which is flexible, and particles of an ion exchange resin immobilized at least one of upon or within the substrate material. The ion exchange resin is functional to interact with ethylene oxide to decrease the concentration of ethylene oxide in an environment (that is, an environment in fluid connection with the composition such that gas of the environment contacts the composition). In a number of embodiments, the substrate is formed from a flexible polymer.

In a number of embodiments, the ion exchange resin is an acid-form, cationic acid exchange resin. The ion exchange resin may, for example, be a macroreticular ion exchange resin. In a number of embodiments, the average particle size of the ion exchange resin is no greater than approximately 100 μm, no greater than approximately 50 μm, or no greater than approximately 40 μm. In a number of embodiments, the particles of the ion exchange resin are coated upon the substrate material by applying a coating formulation including the particles of the ion exchange resin and a binder to the substrate material or the particles of the ion exchange resin are mixed with the substrate material. The substrate material may, for example, be formed as a sheet which is coated with the coating formulation or a mixture of the substrate material and the particles of the ion exchange resin may be formed into a sheet.

The substrate material may, for example, be a woven or a non-woven fabric. In a number of embodiments, the substrate material is a non-woven fabric. In a number of embodiments, the non-woven fabric includes a polyalkylene or polyolefin (for example, a polypropylene).

In a number of embodiments, the substrate material includes a thermoplastic polymer and the particles of the ion exchange resin are mixed with the substrate material via extrusion of the particles of the ion exchange resin with the substrate material (for example, in the form of a sheet). In such extruded compositions/sheets hereof, the particles of the ion exchange resin may have an average particle size no greater than approximately one half of the thickness of the sheet in a number of embodiments. The mass percent of the particles of the ion exchange resin in the sheet may, for example, be at least 2%, or optionally at least 5%. In a number of embodiments, the mass percent of the particles of the ion exchange resin in the sheet is not greater than approximately 15%. The thermoplastic polymer may, for example, be selected from the group consisting of a polyalkylene or polyolefin, a polystyrene, a polyvinylidene chloride and a polyvinylchloride. In a number of embodiments, the thermoplastic polymer is selected from the group consisting of a polyalkylene or polyolefin, and a polyvinylchloride. In a number of embodiments, the thermoplastic polymer is a polyethylene. The extruded sheet may, for example, have a thickness in the range of approximately 1-10 mil, or optionally in the range of 1-5 mil, and the particles of the ion exchange resin have an average particle size no greater than approximately one half of the thickness of the sheet. In a number of embodiments, the sheet has a thickness in the range of approximately 4-5 mil, and the particles of the ion exchange resin have an average particle size no greater than approximately one half of the thickness of the sheet.

A device for reduction of concentration of ethylene oxide in an environment in which the device is placed in fluid connection, includes a composition as set forth herein. The device may include a sheet wherein the particles of the ion exchange resin are coated upon the substrate material, which is formed as a sheet, by applying a coating formulation including the particles of the ion exchange resin and a binder to the sheet or the particles of the ion exchange resin may be mixed with the substrate material in forming a sheet. In a number of embodiments, the substrate material includes a thermoplastic polymer and the particles of the ion exchange resin are mixed with the substrate material via extrusion of the particles of the ion exchange resin with the substrate material. The sheet may, for example, be formed into a cover, a wrap, a package, a curtain, or a filter. In a number of embodiments, the sheet is formed into a pallet cover or a pallet wrap.

A method of reducing a concentration of ethylene oxide in an environment includes placing a device hereof in fluid connection with the environment. The environment may, for example, include one or more articles that were sterilized using ethylene oxide. As described above, the device may include a cover, a wrap, a package, a curtain, or a filter. In a number of embodiments, the device includes one or more sheets formed into a pallet cover or a pallet wrap and the method includes placing the pallet cover or the pallet wrap in connection with a pallet including a plurality of the articles.

A system hereof includes one or more articles that were exposed to (for example, sterilized using) ethylene oxide and a device hereof positioned adjacent the one or more articles (such that ethylene oxide outgassed from the one or more articles contact the device).

The present devices, systems, and methods, along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates schematically an embodiment of a system for the manufacture of an embodiment of an EtO neutralizing material hereof including a flexible sheet with a surface coating including ion exchange resin or IER particles, wherein the coated sheet is fabricated by passing a flexible sheet through a dip tank containing a binder and the IER.

FIG. 2 illustrates schematically an embodiment of a system for the fabrication of an embodiment of an EtO neutralizing material hereof including a sheet coated with a coating including IER particles, wherein the system includes spray nozzles which apply the IER particles blended with a binder to the surface(s) of the sheet.

FIG. 3 illustrated schematically an embodiment of a system for fabricating an embodiment of an EtO neutralizing material hereof via extrusion of a polymeric material with IER particles.

FIG. 4 illustrates schematically an embodiment of a pallet wrap hereof in connection with a pallet.

FIG. 5 illustrates schematically a pallet enclosure device or system hereof in position to be placed over a pallet.

### DETAILED DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “a sheet” includes a plurality of such sheets and equivalents thereof known to those skilled in the art, and so forth, and reference to “the sheet” is a reference to one or more such sheets and equivalents thereof known to those skilled in the art, and so forth. Recitation of ranges of values herein are merely intended to serve as a shorthand method of referring individually to each separate value falling within the range. Unless otherwise indicated herein, each separate value, as well as intermediate ranges, are incorporated into the specification as if individually recited herein. As used herein terms such as “approximately”, “about” and similar terms in connection with a value or a range of values refer to values with 10% (or with 5%) of the stated value or range of values unless the context clearly dictates otherwise. All methods described herein can be performed in any suitable order unless otherwise indicated herein or otherwise clearly contraindicated by the text.

As used herein, the term “polymer” refers to a chemical compound that is made of a plurality of small molecules or monomers that are arranged in a repeating structure to form a larger molecule. Thus, a polymer is a compound having multiple repeat units (or monomer units) and includes the term “oligomer,” which is a polymer that has only a few repeat units. The term “copolymer” refers to a polymer including two or more dissimilar repeat units (including terpolymers—comprising three dissimilar repeat units—etc.). Polymers may occur naturally or be formed synthetically. The use of the term “polymer” encompasses homopolymers (having a single repeat unit) as well as copolymers. The term “copolymer” is used herein to include any polymer having two or more different monomers. Copolymers may, for example, include alternating copolymers, periodic copolymers, statistical copolymers, random copolymers, block copolymers, graft copolymers etc.

A primary application of materials or compositions hereof is to control the emissions of EtO (from, for example, pallets of medical supplies that have been sterilized with EtO). Pallets of EtO-sterilized medical supplies are typically about four feet (48 in) wide, about 3.5 feet (42 in) deep and about four to eight feet in height. Such pallets often have pallet wraps on them to keep the pallet together.

In a typical scenario, pallets of medical supplies/devices are sterilized with EtO, which takes about 12 to 20 hours depending on the sterilization parameters, including preconditioning and sterilization steps. The sterilized pallet is then typically aerated for another 12 to 24 hours to remove most of the residual EtO. The aeration step can be in the same chamber as sterilization or in a different chamber, depending on the design of the facility. After the pallets are removed from aeration, they are typically moved to a warehouse until they are loaded into, for example, truck trailers and shipped out to a distribution center. At the distribution center, the pallets may be shipped to other distribution locations, or the pallets may be broken down, and the contents placed in the warehouse, ready to be supplied to end-users. While the aeration step will remove most of the EtO, residual EtO in the pallets will remain and slowly diffuse out of the pallets into the surrounding air. Such off-gassing will occur while the pallets are in the warehouse, during transportation, and when the pallets are broken down in the distribution center. As described above, the EtO off-gassing is usually approximately an exponential decay and the time needed will depend on many factors including the temperature, product materials and packaging in the pallets as well as the way the pallets were assembled. Standard aeration for gas-sterilized plastics, J. D. White, J. Hyg., Camb. (1977), 79, 225.

As also described above, EtO is carcinogenic and the off-gassing from large numbers of pallets can result in enough EtO being released into the warehouse to present a hazard to workers present in the warehouse. Facilities often have to install expensive additional ventilation to keep the EtO concentration below the OSHA permissible exposure limit of 1 ppm, time weighted average over 8 hrs. Occupational exposure from continued EtO off-gassing is a recognized problem for medical device manufacture and other industries.

At least a partial solution is to increase ventilation during transportation from the EtO sterilization facility to the distribution center, but this approach is not practical since most trucks and trailers are those of common carriers and are not usually ventilated. The result is that the off-gassed EtO can build up in the trailer and potentially pose a hazard to workers tasked with unloading the trailer and subsequently breaking down the pallets. Another solution is to increase the time between when trailers and shipping containers are opened and the pallets are unloaded to allow the load time to aerate, but doing so adds delay to the supply chain. As described above, such problems are known in the industry, but to date no good solution has been developed.

In general the compositions, devices, systems, and methods hereof provide a small, light-weight, and low-cost product that removes EtO efficiently with no external power, and which may, for example, be provided in a slim flexible form that can be placed around and between pallets or boxes. Whether in the form of a pallet cover, a pallet wrap, which may draped over the EtO sterilized pallets after aeration, or other form, the compositions, devices, systems, and methods hereof will remove and neutralize off-gassed EtO.

A desired form of materials or compositions hereof is similar to current pallet wraps and covers, since sterilization facilities will already have the equipment and people skills to apply such wraps and covers. Pallet wraps in current use are typically 4- to 18-inch wide, thin polyethylene films that are wrapped around the pallet. The wrapping process can be done by machine or by hand. Materials or compositions hereof may readily be manufactured to such a form and use.

Another form is a pallet cover that is placed over the pallet, enclosing the entire pallet. However different size pallets will require different sizes of pallet covers. A format that avoids the multiple size issue is to provide the EtO neutralizing material on a 48 inch wide roll, such that strips can be cut and draped over the pallet. For example, a 5 foot high pallet will need two strips, each of 14 feet long, draped orthogonally to each other across the top of the pallet. The sheets may, for example, be held in place with a small amount of conventional pallet wrap. It may also be desirable to line the walls of the trailer or shipping containers with the EtO neutralizing material. A 48 inch roll would be a convenient format for dispensing this material, prior to attaching to the walls. However, other configurations are possible including, for example, rolls having a width less than 48 inches.

The compositions or materials hereof may also be applied in other forms or formats if so desired. One of the ways to prevent EtO gas concentration building up with a pallet of EtO sterilized medical devices is to pack the device such that there are channels leading to the outside of the pallet, thus venting the pallet. It may be desirable to place sheets of the EtO neutralizing material between the boxes of medical devices comprising the pallet, post-sterilization, or it may be desirable to place a cylinder of the EtO neutralizing material hereof within a channel post sterilization. As discussed above, one of the advantages of EtO sterilization is that medical devices can be sterilized by the pallet. Typically, each device will be enclosed in a porous package that allows entry of the EtO gas for sterilization, but the pore size of the packaging is such that bacteria and other pathogens are unable to enter the package until use, thus maintaining sterility. These inner packages will often be packed together in larger boxes, which in turn are assembled to form the pallet.

In a number of embodiments hereof, the EtO neutralizing material hereof may be packed in sachets, envelopes, porous bags, porous containers or simple sheets that can be placed in the outer boxes containing the EtO packaged sterilized devices to remove any EtO that off-gasses from the sterilized packages, especially after the pallets have been broken down to smaller boxes for storage or shipment to the end user.

In whatever physical configuration they are provided, materials hereof may satisfy a number of, and preferably all of, the following desirable characteristics:
Low cost
Simple to manufacture.
Light weight (do not want to add too much extra weight to shipment).
Small volume (do not want to add too much volume to shipment).
Easy to handle, that is, easy to pick up and place by hand (small beads for example would be an impediment).
Flexible/bendable—can be folded if needed, but should be strong enough that the material can be pushed between boxes if needed.
No hazardous liquid chemicals inside that could potentially leak.
Not fragile, nothing to break, for example if dropped or flexed.
Non-hazardous to skin or eyes if contacted.
No hazardous vapors prior to and subsequent to exposure to EtO.
Non-hazardous waste, so can be disposed of in regular trash. Therefore, no heavy or toxic metals, no toxic compounds that can be leached out by water.
Devices should permanently remove the EtO, not just absorb it such that EtO can later desorb as can occur with simple absorbents such as activated carbon.

In a number of embodiments, compositions, devices, systems, and/or methods hereof extend the functionality of ion exchange resins or IERs by affixing or immobilizing such IERs within and/or upon a surface of a material so that the gas (typically, air) including EtO can reach the IER via diffusion and/or natural convection. Unlike scrubbers including, for example, columns of IERs, the materials or compositions hereof may be applied in applications where there is neither external power to run blowers, nor any blowers or fans to move the air. If an application does have some means for mechanical movement of air, the materials or compositions hereof will also function as well or even better in that application.

Without limitation to any mechanism, the inventors believe that the reaction between acidic functional groups in an acidic IER and EtO forms a sulfonic acid ester of ethylene glycol or polyethylene glycol (PEG) as set forth below.

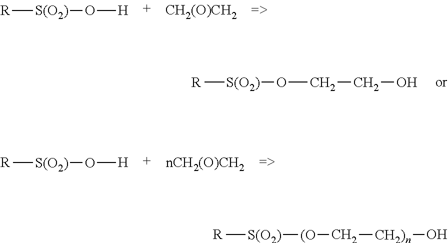

From a utility perspective, the EtO is removed from the air and chemically converted to another non-volatile and much less harmful compound. In the presence of excess moisture or humidity, the reaction product may be partially hydrolyzed to form low levels of relatively harmless ethylene glycol or PEG, but the IER will not release EtO. The results of leaching tests with similarly reactive materials indicate that very little ethylene glycol is formed and so the majority of the EtO ends up as PEG that either dissolves in the water or remains bound to the surface as the sulfonic acid ester. The EtO is thus removed from the surrounding environment and converted to another chemical species which remains bound to the surface of the polymer.

Strong bases can also be used to catalyze these reactions, and the use of a strongly basic ion exchange resin is within the scope of this invention. As used herein a strong base has a pKa>13. A strongly basic ion exchange resin for the purposes of this disclosure is an anion exchange resin in the hydroxide (OH⁻) form; however, based on laboratory testing, the strong acid IERs performed better and are more desirable IERs for a number of embodiments of the compositions hereof.

IERs typically come in two physical forms depending on how they are manufactured. The most common form is a gel-type IER, wherein the pore size is determined by the type and percentage of cross linking agent used in the manufacture of the IER. Such resins tend to swell or shrink depending on the water content and have a small pore size (a range of approximately 1 to 2 Å is typical). A second typical form is a macroreticular or macroporous IER, which is synthesized with a rigid structure. Such IERs usually have a much larger pore size (a range of approximately 200 to 400 Å is typical). In a number of embodiments hereof, the IER is a strongly acidic resin in the acid (H⁺) form, and in a number of desirable embodiments, the IER is a strongly acidic macroreticular resin in the acid (H⁺) form. A strong acid has a pKa<1. Strong acid ion exchange resins typically include sulfonic acid groups. Although various types of IER may be used herein, laboratory testing has shown that the macroreticular resins perform better in a number of applications of the materials hereof than the gel types resins. However, IERs of the microporous form may also be used.

Most IERs are manufactured as spherical resins, where the resin size is between 0.2 to 01.0 mm. Such IERs may be used in materials or composition hereof as provided by the manufacturer. However, much better performance is obtained if the IER is ground to a powder with an average particle size or average diameter of less than 100 μm, and more desirably in a number of embodiments less than 50 μm. The grinding process may be a conventional grinding process as known in the polymer arts. A smaller particle size or particle diameter facilitates stability of mixtures used to form coatings as well as more uniform extruded films as further discussed below.

In a number of embodiments hereof, an IER is immobilized upon a substrate by applying a coating containing the IER to the substrate. As used herein, the term “coating” includes layers applied via, paints, stains, sprays, inks, etc. whether the applied coating remains on the surface of the substrate or at least partially penetrates into the surface or bulk of the substrate. There are many types of coatings or application techniques that can be used within the scope hereof, provided they form a coating on the surface or impregnate the exterior of a surface so as to fix the IER powder to the substrate.

There are numerous coatings compositions that have been formulated for various applications and methods. One skilled in the art, can readily formulate a coating to apply an IER to a surface of a substrate as described herein. In that regard, the art of formulation of coatings containing suspended solid particles, such as pigments, and the physical principles involved in selecting appropriate components is well known in the coatings industries including, for example, the formation of inks, paints and textile coatings. Formulating a coating containing an IER for implementation in compositions hereof, in light of the present disclosure, including the representative examples hereof, is similarly within the skill set of, for example, formulation chemists and others of ordinary skill in the coating arts. See, for example, European Patent No. EP0837110 and U.S. Pat. No. 3,494,878. The following representative guidelines may, for example, be used in formulating a number of embodiment of coatings hereof:
The solvent is desirably water-based for environmental reasons, though organic solvents may be used in formulating compositions hereof.
The IER in a number of embodiments is a macroreticular strong acid, cation exchange resin, in the H⁺ form that has been formed (for example, ground) to a maximum particle size of <100 μm, and more desirably <40 μm. In general, the smaller the particle size, the more stable the suspension formed (as per Stoke's law). In a number of embodiments, the moisture content of the resin beads is about 55%. However, a lower moisture content percentage of, for example, under 20%, or even under 5% may be more desirable.
The binding agents may be conventional, for example, emulsion polymers based on acrylics or polyurethanes. In a number of embodiments, the binding agent is a water/solvent soluble polymeric material, either natural or synthetic, at a concentration with a dynamic viscosity of at least 800-1000 cP. Suitable binding agents include, but are not limited to, acrylic-based, styrene-acrylic based or styrene-butadiene based polymers with low glass transition temperatures (T_{g}s) that allow for flexible film formation under typical conditions. In a number of embodiments, a maximum T_{g} is in the range of −40 to 0° C. In a number of embodiments, the maximum T_{g} −20° C. Such T_{g}s will maintain flexibility of the materials hereof over the temperature range of typical use. The binding agents may, for example, be self-crosslinking polymers or polymers that require a small amount of crosslinking agent along with a catalyst to encourage film formation. The binding agents may have properties such as water resistance, chemical resistance and uv-resistance. The binding agents are desirably stable over a wide range of pH preferably in the range 2-12, most preferred is 2-4. The binding agents may, for example, be water soluble or organic solvent soluble, though low VOC water soluble is desirable for used in compositions hereof. A typical percentage of binding agent used may, for example, be between 15-40% of the weight of the coating mixture.
To limit or prevent sedimentation of IER particles, suitable rheology modifiers may be used. Suitable rheology modifiers include nonionic, non-associative thickeners that are cellulose- or clay-based, or associative acrylic thickeners such as alkali swellable or hydrophobically modified alkali swellable or nonionic associative thickeners such as hydrophobically modified ethoxylated polyurethanes. Castor oil derivatives and wax emulsions may also be used as thickeners. Such thickeners will exhibit rheological properties such as shear thinning behavior, sag resistance, levelling and spatter resistance. The thickeners facilitate adjustment of viscosity to levels that are suitable for application methods while keeping the resin particles in suspension. A typical level of usage may, for example, be between 0.1-3% of the coating weight. One or more types of thickeners may also be used.
To prevent flocculation of the ion exchange resin powder, suitable dispersing agents may be used. Dispersing agents keep the suspended particles from aggregating together by providing electrostatic stabilization or stabilization by steric hindrance. Dispersing agents may be combined with wetting agents and added during the grinding process of the ion exchange resin to facilitate grinding to smaller particle sizes as well as an efficient dispersion stability. Dispersants that are commonly used to disperse organic and inorganic pigments in both water-borne and solvent-borne inks and paints formulation may be used. These dispersants and wetting agents can be surface active compounds such as nonionic surfactants or polymeric dispersants or block copolymers with anchorage groups. Polyvinyl alcohols, ethoxylated alcohols, polyethylene glycols, polyurethane dispersants, amine ethoxylates and silicone based dispersants may be used. Typical amounts of dispersing agents used is 0.1-3%.
The binder(s), thickener(s), dispersant(s) and other additive(s) such as wetting agents, defoaming agents and preservatives are desirably non-ionic. The presence of a high concentration of ions in the binder, thickener, dispersants and other additives such as wetting agents, defoaming agents and preservatives can reduce the overall capacity. Depending on the selectivity, some of the ions in the coating might exchange with some of the protons at the exchange sites, which could affect the performance of the ion exchange resin. For example, if there are high concentrations of cations (including metal ions such as sodium), in the solution, those ions may exchange with the protons in the IER, and the IER will either no longer remove EtO or it will have reduced capacity.
A representative example of a suitable binder of a number of studies hereof is methyl acrylate based binder and a representative example, of a suitable dispersant is poly vinyl alcohol.

The IER coating may, for example, be applied to virtually any substrate via a number of conventional methods, typically involving applying the coating mixture, and then either drying it or allowing it to dry to form the coating. For applying a coating mixture hereof to fabrics (including, woven and non-woven fabrics), the methods of textile finishing may be applied, including, for example, dip/pad coating, spraying, foam coating, knife coating, kiss coating etc. For fabrics, the preferred application methods include dip/pad coating and knife coating. Those methods are well known within the art of textile finishing, and selecting the appropriate method is well within the capabilities of those of ordinary skill in that art.

Similarly, many conventional printing methods may be used for applying the IER as an ink to diverse substrates, including, for example, screen printing, digital printing, offset printing, and ink-jet printing. Among printing processes, a preferred printing method is offset printing. Likewise there is a wide range of conventional techniques for applying paints to surfaces, including, for example, roller, brush, spray, scatter coat, and powder coat. Such application methods are well known and widely used in many industries, and selecting an appropriate method is well within the capabilities of those of ordinary skill in the coating application arts. Representative examples of a number of coatings and paints are described below and in the examples hereof. Those descriptions and examples are intended to be illustrative and not to limit the scope hereof.

In general, the substrates hereof can be any porous or non-porous solid material that can accept a composition or formulation including TER particles (such as a paint or ink) for immobilization thereof. Representative suitable materials include paper, cardboard, woven and non-woven textiles, polymer films, and metal foils. As apparent to those skilled in the art, there is a very diverse range of substrates that can accept formulations such as paints and inks and are, thus, suitable for use herein. In a number of embodiments, substrates are used which provide the most utility for use in a particular EtO off-gassing applications. Representative substrates suitable for off-gassing applications include, for example, paper sheets and rolls, polymeric (for example, polyethylene) pallet wrap and pallet covers, as well as non-woven and woven fabrics. As described above, an important application for materials hereof is removing off-gassed EtO from EtO-sterilized pallets during transportation. Suitable substrates for such an application may, for example, be suitable to be placed over, around or between the pallets, or be suitable to line the shipping container or truck trailer containing the pallets. Other applications for materials or compositions hereof, include liners for warehouse shelves in medical device distribution centers that distribute EtO sterilized medical devices, and fabrication of bags, sachets, porous containers or other special packaging for the sale, storage or transportation of EtO sterilized products. Such packaging may, for example, be used to help ensure the removal of any last vestiges of EtO that off-gas from a sterilized device prior to use thereof.

In a number of representative embodiments, substrates hereof are flexible such that the devices and systems hereof may be wrapped around or draped over potential sources of EtO gases. Representative examples include flexible sheets which can, for example, be draped over pallets or pallet wraps. Such sheets may, for example, when used as a wrap, have properties which are similar to cling-films, and may, for example, be used to aid in holding the contents of a pallet together. A substrate material for a pallet wrap may also be slightly tacky so that the devices and system hereof are able to self-adhere. A substrate for a pallet drape may, in certain embodiments, be a flexible sheet that has or is formed from or material that has properties similar to polyethylene, polyvinylchloride, polyvinylidene chloride and other flexible thermoplastic polymers. One skilled in the art may readily select a suitable substrate for user herein using known engineering principles based upon the requirements for a particular use.

The EtO neutralizing materials hereof may, for example, also be used to form pleated or other filters for air handling equipment to remove low levels of EtO in, for example, a warehouse that stores or distributes EtO sterilized medical devices.

Material properties for substrates are readily determined for various embodiments of devices hereof that can, for example, be used as a wrap to be placed around pipes, valves, flanges etc. for EtO removal in, for example, chemical plants that use EtO. There is considerable regulatory pressure on chemical plants to reduce EtO emissions, and one of the major sources of EtO leaks are leaks in the plumbing, i.e. valves, seals, flanges etc. By wrapping potential leak locations with an EtO neutralizing fabric or other material hereof, or encasing it in an IER impregnated foam, sealant or other material hereof, the rate of EtO loss to the atmosphere can be significantly reduced. Thus, the type of substrate that may be used within the scope of this invention is very diverse. As clear to those skilled in the art, the specific application will determine the preferred form and physiochemical properties of the materials, which are readily achievable by those skilled in the art.

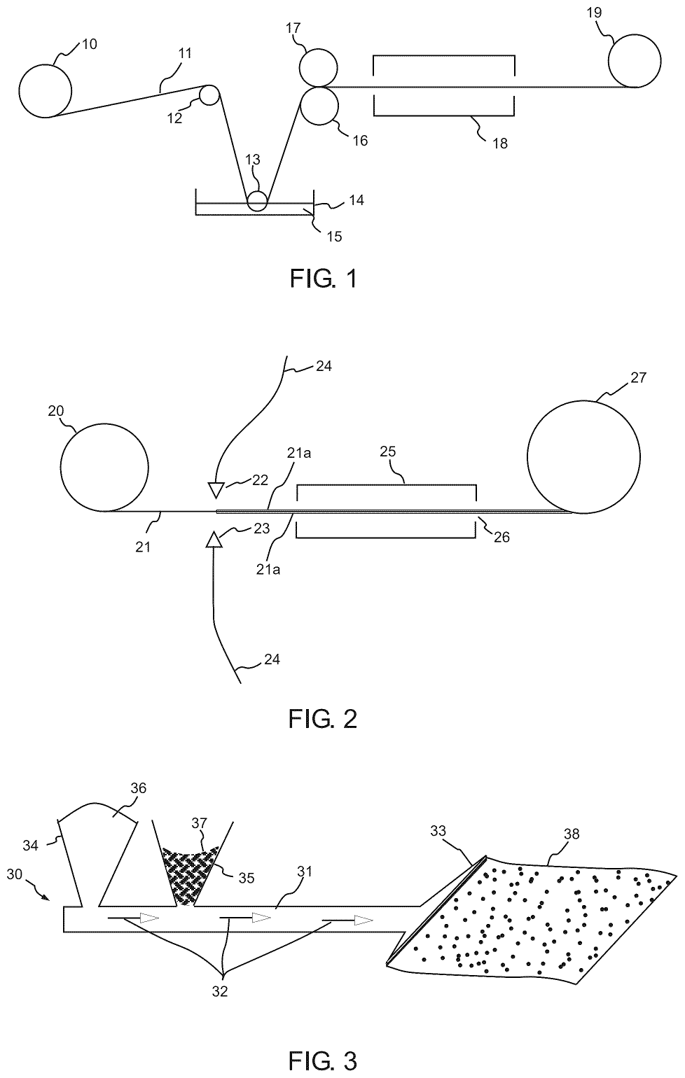

FIG. 1 illustrates a simplified schematic drawing of a dip tank process commonly used for treating textiles. In the illustrated embodiments, a roll 10 of fabric 11 is passed over a roller 12 and under second roller 13 in a dip tank 14, wherein second roller 13 is at least partly submerged in a coating solution 15. The now wetted fabric 11 passes between a pad squeezer, comprising a roller 16 and a rubber pad 17 to remove excess liquid. Fabric 11 next passes through a dryer 18 before being rolled up again on roll 19.

As indicated above, textile finishing is a well-established industry, and there are many ways to apply a coating to a fabric. The dip tank in FIG. 1 is an illustration of a representative method that is commonly used to apply coatings to fabrics, which is applicable to various substrates and coating formulations. There are many other methods available for coating fabrics, including, for example, roller coating, gravure coating, foam coating, spraying, knife coating and kiss coating. Such methods are well known and widely used in, for example, the textile finishing industry. There are also many ways of drying fabrics, including, for example, heated air drying, hot cans, and infrared heating. Selecting a suitable method to apply the coating and dry the coating upon the fabric, and the conditions under which to use such methods are well within the skill of those experienced in the art of, for example, fabric finishing. The method selected will often depend on the equipment that is available in a particular manufacturing facility.

FIG. 2 illustrates schematically a representative embodiment of a substrate being coated by spraying. In the illustrated embodiment, a roll 20 of the substrate 21 is passed between two banks of spray nozzles, one bank 22 of spray nozzles is located above substrate 21, and another bank 23 of spray nozzles is located below substrate 21. The spray nozzles of banks 22 and 23 are fed by feed pipes 24, which draw a coating formulation from coating reservoirs (not shown), and deposit a thin film 21a on substrate 21. Coated substrate 21 then passes through a dryer 25, exits dryer 25 via outlet 26, and is rolled up on to another roll 27. The process in FIG. 2 is representative of one manner in which a thin film of a coating including IER particles can be deposited onto substrate 21. Substrate 21 in FIG. 2 may, for example, be a flexible, generally planar material (for example, a sheet of film) such as paper, a plastic film, or a non-woven fabric or a woven fabric. It will be clear to those skilled in the art of depositing surface coatings that many other formats and application methods may be used to deposit a coating on a substrate such as substrate 21.

In a number of representative embodiments, coatings hereof are approximately 50% by weight of the final product, with the substrate (for example, nonwoven polypropylene) being the other 50%. A range for the coating would be (10 to 80%). In a number of embodiments, the IER is approximately 2 to 40%, or optionally 10 to 20%, of the coating. The thickness of the flexible coating may vary depending upon the required performance for a specific use. As the coating does not required independent structural stress, the coating can be relatively thin as long as the EtO removal is sufficient for a specific use.

As described above, the binder may, for example, be a non-ionic polymer. In a number of embodiments, the coatings hereof include an acrylic-based binder polymer. An aqueous suspension of the binder polymer may, for example, have a pH<4. Representative thickeners (and other additives—for example, binder(s), thickener(s), dispersant(s), pigment(s), defoamer(s), wetting agent(s), etc.) suitable for use herein may, for example, be non-ionic and stable at the pH of the aqueous suspension. Representative examples of thickeners for use herein include cellulose or polyurethane-based polymers. A representative example of a dispersing agent is polyvinylalcohol.

In another representative embodiment hereof, ion exchange particles may be mixed with a material or bulk material in forming a composition, device or article hereof. For example, the material may include a thermoplastic polymer and the ion exchange particles may be mixed with the material during an extrusion process to incorporate the ionic exchange particles in the material. A representative example of an extrusion process hereof is illustrated as a simplified and schematic form in FIG. 3. In the illustrated embodiment, extruder 30 includes a heated extruder tube 31 that houses a screw auger (not shown) as known in the extrusion arts. Extruder 30 and the screw auger thereof heat a polymer 36 to its melting point and the screw auger drives polymer 36 forward in the direction of the arrows 32. IER 37 is added to polymer 36, and the two components are mixed by the action of the screw auger. The melt temperature of polymer 36 is less than the melt temperature of the polymer used in forming IER 37 so that the IER particles remain in solid form during the extrusion process. The mixture of hot melted polymer 36 and IER 37 is passed through the extruder tube 31 and forward to the extruder head 33, which is shaped to form the polymer mixture into the desired form such as a sheet 38 as shown in FIG. 3. In the illustrated embodiment, extruder 30 is fed by two hoppers 34 and 35, which contain polymer 36 and IER 37, respectively. Polymer 36 and IER 37 are fed from the hoppers 34 and 35 into extruder tube 31 at a controlled ratio to get the desired final mixture. A double-hopper extruder is illustrated, but a single-hopper extruder and pre-mixing of polymer 36 and IER 37 in the appropriate ratio may also be used. Extruded sheet 38 cools rapidly on exiting extruder head 33, and can be rolled up into a roll (not shown) or passed to another machine (also not shown) if secondary processing is required. Extruder 30 shown in FIG. 3 is an illustrative, representative embodiment. The art of polymers extrusion is well developed, and there are many variations on the extrusion equipment available that may be used in extrusion processes hereof.

There are many thermoplastic polymer films that are suitable for use herein. However, based on a goal of a low cost product, polymers such a polyethylene (PE) and polyvinyl chloride (PVC) are desirable for use herein. Of those polymers, PE is the more desirable because it is manufactured in large quality and at low cost. PE and PVC are chemically inert, flexible thermoplastic polymers which are readily extruded as a thin film. Most pallet wrap materials used today are made of PE, because it is inexpensive, flexible, strong, and relatively inert. Pallet wraps are wrapped around pallets to ensure that the contents do not shift or fall during transportation. Although PE is very suitable for use herein, it will be apparent to those skilled in material sciences and related arts that other polymers can also readily be used. By keeping the mass percent of the IER below a defined threshold for a particular polymer (for example, less than 15% mass), the co-extruded film retains essentially similar mechanical strength and most other physical properties as films made from the polymer only. The extrusion process hereof can be a single step process, extruding polymer pellets and IER to form the film, or it could be performed in multiple steps (for example, first co-extrude the polymer and the IER to form pellets, and the later extrude the pellets to form the film or other product).

The extrusion process and equipment used herein may be conventional. The relatively minor changes in extrusion conditions needed to accommodate the blended polymer extrusion are well within the scope of those experienced in the art of polymer compounding and extrusion. Various additives may be added to the polymer being extruded. Such additives include, but are not limited to, dyes and pigments, plasticizers, opacifiers, photo-stabilizers and solids (powders). The incorporation of additives or blends of additives into extruded polymers is common practice in the plastics industry. Any additive should be chemically compatible with the polymer and the IER being used. For example, if the additive is basic, it may neutralize some of the acid functionality of the IER and make the film less effective for the removal of EtO. Similarly, if a proposed additive is susceptible to acids, it should be avoided in the case of an acidic IER. For example, many plasticizers are esters and esters can be hydrolyzed by acids and should typically be avoided for use with acidic IERs. Also, as discussed above, nonionic additives are preferable over ionic additives. The assessment of chemical compatibility and the selection of alternative additives is within the ordinary skill of those experienced in the art of extruded polymer formulation and many non-ionic binders and thickeners are available commercially.

Using PE as an example, the co-extruded PE film may be formed to have mechanical properties similar to a film including only of PE. However, unlike the PE film, the extruded film hereof contains the IER and can be used to remove EtO from air. Since any acid (or base) functionality is chemically bound within the IER, the film can be handled without special precautions, because the remaining acidic functionality (or basic functionality) is fixed within the IER and does not come off. Similarly, the IER cannot be leached from the PE film by groundwater, and so the PE/IER co-extruded product can be disposed of as non-hazardous waste.

A number of embodiments of devices or systems hereof may be formed as a films or sheets, but other forms, shapes or configurations may be desirable depending on a specific application and are within the scope hereof. For example, a film may be extruded as a thin-walled tube, which in turn may heat-sealed and cut to fabricate pallet covers. As described above, extruded films hereof may have mechanical properties generally similar to a corresponding polymer film without the IER (for example, PE) and thus are amenable to being manufactured into any item that is conventionally manufactured from the polymer, including sheets, bags, pallet covers, pallet wraps, packaging materials etc.

In other embodiments hereof, the IER can be incorporated into a material via mixing during its manufacture other than via extrusion. For example, if the material is a paper-based material, the IER can be blended with the pulp mixture used to form a paper sheet, thereby incorporating the IER within the matrix of the paper sheet and not just at the surface.

As discussed above, a suitable method of preparing IER particles hereof is to grind the IER to a powder with a particle size of less than 100 μm, or less than 50 μm. However, for certain extruded films, smaller particle sizes may be desirable. Particle size may be particularly important if the extruded film is thin. For example, pallet stretch wrap is typically 40 to 150 gauge (10 to 38 μm) thickness depending on the nature of the load to be wrapped. The particle size of the IER extruded in the film is smaller than the thickness of the film in a number of embodiments hereof. Using larger particles increases the likelihood that the extruder will become blocked. Further, having particles with a size comparable to the thickness of the film (or larger) embedded within the film may result in weak spots in the film. In general, the maximum particle size should be less than 50% of the thickness of the extruded film.

Even though the IER may be partially or fully embedded within the polymer film, the extruded films have been found experimentally to remove EtO well. EtO can diffuse through polymers to a significant degree. See, for example, “Transport of ethylene oxide through polymer films,” A. Phatak, C. M. Burns, R. Y. M. Huang, J. Appld. Polymer Sci. Volume 34, Issue 5, October 1987, Pages 1835-1859, https://doi.org/10.1002/app.1987.070340505; Komarkova N I, Likhtman T V. Diffuziia okisi étilena v polimernykh materialakh meditsinskogo naznacheniia (Diffusion of ethylene oxide in polymer materials intended for medical use). Med Tekh. 1983 May-June; (3):33-8. Russian. PMID: 6888220.] The coating and extrusion composition hereof have been found to not significantly affect the ability of acid or basic groups of the IERs from interacting with EtO. For example, in diffusing into and through the polymer film hereof, EtO will encounter the acid functional groups of a strongly acidic IER and interact therewith as described above.

The optimum ratio of the IER to the polymer depends primarily on two main factors. The minimum is determined by the need for EtO removal, both the rate of removal and the amount that can be removed. Experimentally, it has been found that the rate of the removal of EtO is the limiting constraint rather than the capacity. If the ratio of the IER to polymer is too small, then the resulting material will be ineffective for removing EtO. The amount needed will of course depend on the amount of EtO that needs to be removed per unit area of the polymer. For typical applications such as removing the EtO off-gassing from EtO sterilized pallets, the minimum concentration of IER is about 2% by mass with greater than 5% by mass being preferred. The maximum ratio of the IER to the polymer will be determined by the required physical integrity of the resulting extruded polymer. If the final extruded product will be a thin film, for example, too much IER will affect the structural integrity of the film. The limit of loading depends on the polymer being used and its molecular weight, the IER being used and its particle size, and the application. For example, if very thin polymer films are required that are expected to endure significant stress, then the maximum IER ratio will be less than for a thicker product with less stress. An acceptable range of and/or an optimum ratio can be readily determined by simple experimentation, in view of the present disclosure, which is well within the ordinary skill of those experienced with formulating polymers for film extrusion.

It will be apparent in light of the disclosure hereof to those skilled in the arts of material science or chemistry that many other polymers and IERs materials can be used within the scope hereof, beyond the representative examples herein. There are many polymers that could be used as the support material in the materials hereof, including, but not limited to, polypropylene, other polyalkenes or polyolefins, polystyrene, polyvinylidene chloride and polyvinylchloride; as well as numerous polymer blends. Further, the selection of a suitable polymer is a routine matter for those of ordinary skill in the art of formulating polymers for use in, for example, film extrusion. There are also many IERs available or which can be readily synthesized that may also be used herein. In practice, in addition to the physical properties, the selection of appropriate polymer and IER depends largely on the cost of the raw materials. Consideration of costs favors, for example, embodiments including polyethylene as the polymer and a finely ground macroreticular strong acid, H⁺ form resin as the IER.

As used herein, the terms “sheet” and “film” both refer to a thin, flat layer of a material. While films, in general use of that term, may be thinner than sheets, the two terms are typically used interchangeably. As discussed above, the polymer film formed from the extruded bulk polymer and IER has generally similar bulk physical properties as a similar sized sheet of the bulk polymer without the IER. If the polymer chosen is a flexible polymer film, such as that commonly used as a pallet cover to hold the contents of pallets together, the extruded film can also be used as a pallet cover. If the contents of a pallet have recently been sterilized using EtO, there is likely to be some residual off-gassing of EtO, and the co-extruded IER/polymer pallet cover will control any EtO emissions. If the co-extruded polymer film is used as the pallet wrap post sterilization, then the pallet wrap will not only hold the pallet contents in place, but also remove any off-gassed EtO.

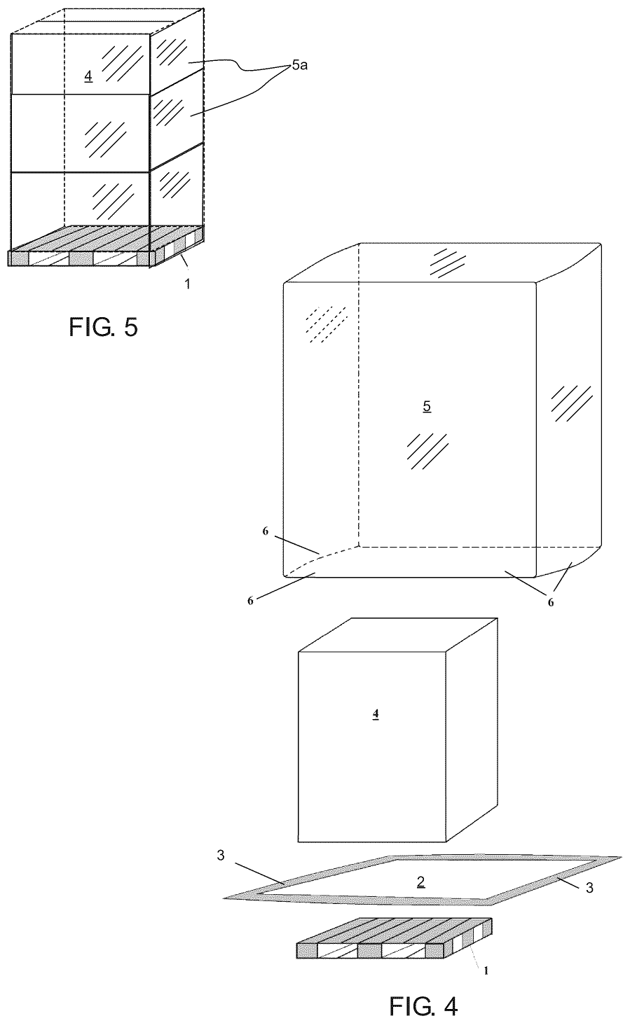

FIG. 4 illustrates an embodiment of a pallet cover device or system 5 hereof which goes over an assembled pallet and seal around the base with, for example, conventional pallet wrap. Most pallets 1 are made of rough wood, though they can also be made of metal plastic and/or other materials. Most pallets have a rough surface and so forming an air-tight seal against the pallet cover is often difficult. In addition, since a wood pallet is made of wood slats, air can pass through the pallet.

If a better seal is required, then a sealing sheet can be added. In the embodiment illustrated in FIG. 4, a sheet 2 hereof is placed in connection with pallet 1. Around the edge of sheet 2 is an adhesive strip 3 with a protective paper layer (not shown) on it. The assembled pallet is built by placing the boxes of medical devices 4 on top of the sheet 2 which is on the pallet 1. A pallet cover 5 is placed over the pallet assembly (1,2,4). The pallet cover 5 is formed of a flexible film or sheet material as described herein. The pallet cover 5 should be large enough that it fits over the product boxes 4 and long enough that it reaches down to the pallet 1. The edges of sheet 2 are pulled up on the outside of pallet cover 5, and the protective paper (not shown) on adhesive strips 3 are removed and adhesive strips 3 are pressed against an area or band 6 including a bottom few inches of pallet cover 5 to form a gas-tight seal therewith. Adhesive strip 3 may be conventional as known in the art. Moreover, many alternative ways of sealing sheet 2 to pallet cover 5 will be apparent to those skilled in the art, including different types of adhesive or different sealing means. For example, adhesive strip 3 can be on the outside of pallet cover 5 and sheet 2 may be pressed against pallet cover 5 to make the air-tight seal.

FIG. 5 illustrates an embodiment of a pallet wrap 5a hereof which with is wrapped around and over an assembled pallet and seal around the base. Pallet wrap 5a may, for example be unwound from a spool of a sheet material hereof such as spool 38. In an alternative embodiment of pallet wrap 5a, a sheet of the EtO neutralizing material can be placed on top of the pallet, such that it hangs down the sides a short distance. The pallet wrap 5a can then be wrapped around the pallet to complete the assembly.

### Experimental Examples

Example 1. A non-woven polypropylene sheet (42 gsm or g/m²) was treated with an aqueous solution consisting of approximately 50% w/w polyvinyl acetate and 10% w/w IER. The IER was ground to a maximum particle size of 100 μm. The coating mixture was applied using a brush and allowed to air dry. A sample of this material (10 cm by 15 cm) was tested by placing the sample in a 1 liter container with an EtO sensor (EtO E-cell® PID sensor from ChemDAQ Inc, Pittsburgh, PA) and filling the container with ˜250 ppm EtO before sealing. The EtO concentration fell with a T₅₀ time (time for the reading to fall to 50% of the original value) of about 15 minutes, showing that the product was removing EtO. A control test without the product showed minimal change in EtO concentration over the same time.
Example 2. A coating mixture was prepared using a textile medium (Chromacryl textile medium from Chroma, Inc. USA). A 1% 2-Hydroxyethyl cellulose (HEC) thickener solution was first prepared by mixing HEC and water and heating the mixture to about 60° C. under constant stirring. A 10% w/w solution of polyvinyl alcohol (with a 98% degree of hydrolysis) was added as a dispersant to the HEC solution, up to 0.8% w/w of the total mixture. The textile medium was added with sufficient stirring (32% w/w of the mixture) and the ground resin was added (˜7% by weight) and the rest was water. This coating mixture was used to treat a nonwoven polypropylene sample (42 g/m²) by dipping and padding at about 35-40 psi. Samples were then dried at 95° C. for 1-2 min. A sample of this material was tested as in Example 1. The EtO concentration fell with a Tso time (time for the concentration to fall to 50% of the original concentration) of about 10 minutes showing that the product was neutralizing EtO. A control test without the coating showed minimal change in EtO concentration over time.
Example 3: Over 1,000 yards of non-woven polypropylene fabric (42 gsm) was coated using a dip tank equipped with a padder in a commercial textile finishing facility. The coating solution comprised an aqueous solution of polyacrylate and 15% w/w IER as described above. The IER was ground to a maximum particle size of 100 μm. After coating the fabric was dried using a gas oven and wound on a roll. The production setup was similar to that described above and shown in FIG. 1. A sample of this material (10 cm by 15 cm) was tested as described in Example 1. The EtO concentration fell, with a Tso time of less than 3 minutes, showing that the product was removing EtO. A control test without the product showed minimal change in EtO concentration over the same time.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A device, comprising: a substrate material, which is flexible, and particles of an ion exchange resin immobilized at least one of upon or within the substrate material, the ion exchange resin comprising functionality to interact with ethylene oxide to decrease concentration of ethylene oxide in an environment.

2. The device of claim 1 wherein the ion exchange resin is an acid-form, cationic acid exchange resin.

3. The device of claim 1 wherein the ion exchange resin is a macroreticular ion exchange resin.

4. The device of claim 1 wherein the average particle size of the ion exchange resin is no greater than approximately 100 μm, an optionally no greater than approximately 50 μm.

5. The device of claim 1 wherein the particles of the ion exchange resin are coated upon the substrate material by applying a coating formulation comprising the particles of the ion exchange resin and a binder to the substrate material or the particles of the ion exchange resin are mixed with the substrate material.

6. The device of claim 5 wherein the particles of the ion exchange resin are coated upon the substrate material.

7. The device of claim 6 wherein the substrate material is formed as a sheet.

8. The device of claim 7 wherein the substrate material is a non-woven fabric.

9. The device of claim 8 wherein the non-woven fabric comprises polypropylene.

10. The device of claim 5 wherein the substrate material comprises a thermoplastic polymer and the particles of the ion exchange resin are mixed with the substrate material via extrusion of the particles of the ion exchange resin with the substrate material.

11. The device of claim 10 wherein the ion exchange resin and the substrate material are extruded in the form of a sheet.

12. The device of claim 11 wherein the particles of the ion exchange resin have an average particle size no greater than approximately one half of the thickness of the sheet.

13. The device of claim 12 wherein the mass percent of the particles of the ion exchange resin in the sheet is at least 2%, or optionally at least 5%.

14. The device of claim 13 wherein the mass percent of the particles of the ion exchange resin in the sheet is not greater than approximately 15%.

15. The device of claim 10 wherein the thermoplastic polymer is selected from the group consisting of a polyalkylene, a polystyrene, a polyvinylidene chloride and a polyvinylchloride.

16. The device of claim 15 wherein the thermoplastic polymer is selected from the group consisting of a polyalkylene, and a polyvinylchloride.

17. The device of claim 16 wherein the thermoplastic polymer is a polyethylene.

18. The device of claim 17 wherein the ion exchange resin is an acid-form, cationic acid exchange resin.

19. The device of claim 18 wherein the ion exchange resin is a macroreticular ion exchange resin.

20. The device of claim 11 wherein the sheet has a thickness in the range of approximately 1 to 10 mil, or optionally in the range of 1 to 5 mil, and the particles of the ion exchange resin have an average particle size no greater than approximately one half of the thickness of the sheet.

21. The device of claim 20 wherein the sheet has a thickness in the range of approximately 4 to 5 mil, and the particles of the ion exchange resin have an average particle size no greater than approximately one half of the thickness of the sheet.

22. The device of claim 1 wherein the device comprises a sheet which is formed into a cover, a wrap, a package, a curtain, or a filter.

23. The device of claim 22 wherein the sheet is formed into a pallet cover or a pallet wrap.

24. A method of reducing a concentration of ethylene oxide in an environment, comprising: placing a device in fluid connection with the environment, the device comprising a substrate material, which is flexible, and particles of an ion exchange resin immobilized at least one of upon or within the substrate material, the ion exchange resin comprising functionality to interact with ethylene oxide to decrease concentration of ethylene oxide in the environment.

25. The method of claim 24 wherein the environment comprises one or more articles that were sterilized using ethylene oxide.

26. The method of claim 25 wherein the device comprises a sheet which is formed into a cover, a wrap, a package, a curtain, or a filter.

27. The method of claim 25 wherein the device comprises one or more sheets formed into a pallet cover or a pallet wrap and the method comprises placing the pallet cover or the pallet wrap in connection with a pallet including a plurality of the articles.

28. A system comprising one or more articles that were sterilized using ethylene oxide and a device comprising a substrate material, which is flexible, and particles of an ion exchange resin immobilized at least one of upon or within the substrate material, the ion exchange resin comprising functionality to interact with ethylene oxide to decrease concentration of ethylene oxide in an environment.
